(19) United States
(12) Patent Application Publication
(10) Pub. No.: US 2026/0181483 A1
(43) Pub. Date: Jun. 25, 2026

(54) TRANSMISSION PROCESSING METHOD AND APPARATUS, TERMINAL, AND NETWORK SIDE DEVICE

(71) Applicant: VIVO MOBILE COMMUNICATION CO., LTD., Guangdong (CN)

(72) Inventors: Erhao SONG, Guangdong (CN); Wei BAO, Guangdong (CN)

(73) Assignee: VIVO MOBILE COMMUNICATION CO., LTD., Guangdong (CN)

(21) Appl. No.: 19/539,510

(22) Filed: Feb. 13, 2026

Related U.S. Application Data
(63) Continuation of application No. PCT/CN2024/111326, filed on Aug. 12, 2024.

(30) Foreign Application Priority Data
Aug. 18, 2023 (CN) 202311046525.4

(51) Int. Cl. H04W 36/00; H04W 36/08

(52) U.S. Cl. CPC H04W 36/0005; H04W 36/0033; H04W 36/0061; H04W 36/08

(57) ABSTRACT

A transmission processing method and apparatus, a terminal, and a network side device. The transmission processing method in embodiments of this application includes: a terminal receives a command for layer 1/layer 2 triggered mobility LTM handover from a source distributed unit DU; and in a case that the command for LTM handover carries a next hop chaining counter NCC, the terminal determines a first key based on the NCC, where the first key is used by the terminal to communicate with a target cell.

### CROSS-REFERENCE TO RELATED APPLICATIONS

This application is a continuation of International Application No. PCT/CN 2024/111326 filed on Aug. 12, 2024, which claims priority to Chinese Patent Application No. 202311046525.4 filed on Aug. 18, 2023, which are incorporated herein by reference in their entireties.

### TECHNICAL FIELD

This application pertains to the field of communication technologies, and specifically relates to a transmission processing method and apparatus, a terminal, and a network side device.

### BACKGROUND

With development of communication technologies, inter-central unit (CU) (Inter-CU) layer 1/layer 2 triggered mobility (LTM) is supported in a communication system. Inter-CU handover involves a change of a packet data convergence protocol (PDCP) entity of a network side device. Therefore, a key needs to be changed. Before performing a next handover, a key of a target cell or a candidate target cell needs to be reconfigured, and a new next hop chaining counter (NCC) needs to be provided for a terminal. In a related technology, a new NCC is usually sent in a radio resource control (RRC) reconfiguration message. Because time required for RRC reconfiguration is long, a new handover may occur on a terminal during RRC reconfiguration. As a result, after the terminal receives the RRC reconfiguration message, the terminal cannot communicate with a target cell. Consequently, there is a problem of poor communication reliability caused by continuous inter-CU handovers in the related technology.

### SUMMARY

Embodiments of this application provide a transmission processing method and apparatus, a terminal, and a network side device.

According to a first aspect, a transmission processing method is provided. The method includes:
a terminal receives a command for layer 1/layer 2 triggered mobility LTM handover from a source distributed unit DU; and
in a case that the command for LTM handover carries a next hop chaining counter NCC, the terminal determines a first key based on the NCC, where
the first key is used by the terminal to communicate with a target cell.

According to a second aspect, a transmission processing method is provided. The method includes:
a source central unit CU sends a next hop chaining counter NCC of a candidate cell to a source distributed unit DU, where the NCC is carried in a command for layer 1/layer 2 triggered mobility LTM handover sent by the source DU to a terminal; and
the NCC may be parsed by the source DU, the NCC is used by the terminal to determine a first key in a handover execution process, and the first key is used by the terminal to communicate with a target cell.

According to a third aspect, a transmission processing method is provided. The method includes:
a source distributed unit DU receives a next hop chaining counter NCC of a candidate cell from a source central unit CU; and
the source DU sends a command for layer 1/layer 2 triggered mobility LTM handover to a terminal, where
the command for LTM handover carries the NCC, the NCC is used by the terminal to determine a first key in a handover execution process, and the first key is used by the terminal to communicate with a target cell.

According to a fourth aspect, a transmission processing apparatus is provided. The apparatus includes:
a first receiving module, configured to receive a command for layer 1/layer 2 triggered mobility LTM handover from a source distributed unit DU; and
a first determining module, configured to: in a case that the command for LTM handover carries a next hop chaining counter NCC, determine a first key based on the NCC, where
the first key is used by a terminal to communicate with a target cell.

According to a fifth aspect, a transmission processing apparatus is provided. The apparatus includes:
a first sending module, configured to send a next hop chaining counter NCC of a candidate cell to a source distributed unit DU, where the NCC is carried in a command for layer 1/layer 2 triggered mobility LTM handover sent by the central unit DU to a terminal, where
the NCC may be parsed by the source DU, the NCC is used by the terminal to determine a first key in a handover execution process, and the first key is used by the terminal to communicate with a target cell.

According to a sixth aspect, a transmission processing apparatus is provided. The apparatus includes:
a second receiving module, configured to receive a next hop chaining counter NCC of a candidate cell from a source central unit CU; and
a second sending module, configured to send a command for layer 1/layer 2 triggered mobility LTM handover to a terminal, where
the command for LTM handover carries the NCC, the NCC is used by the terminal to determine a first key in a handover execution process, and the first key is used by the terminal to communicate with a target cell.

According to a seventh aspect, a terminal is provided. The terminal includes a processor and a memory, and the memory stores a program or an instruction that can be run on the processor; and when the program or the instruction is executed by the processor, the steps of the method according to the first aspect are implemented.

According to an eighth aspect, a terminal is provided. The terminal includes a processor and a communication interface. The communication interface is configured to receive a layer 1/layer 2 triggered mobility command for LTM handover from a source distributed unit DU; and the processor is configured to: in a case that the command for LTM handover carries a next hop chaining counter NCC, determine a first key based on the NCC, where the first key is used by the terminal to communicate with a target cell.

According to a ninth aspect, a network side device is provided. The network side device includes a processor and a memory, and the memory stores a program or an instruction that can be run on the processor; and when the program or the instruction is executed by the processor, the steps of the method according to the second aspect are implemented, or the steps of the method according to the third aspect are implemented.

According to a tenth aspect, a network side device is provided. The network side device includes a processor and a communication interface.

In a case that the network side device is a source CU, the communication interface is configured to send a next hop chaining counter NCC of a candidate cell to a source distributed unit DU, where the NCC is carried in a layer 1/layer 2 triggered mobility command for LTM handover sent by the central unit DU to a terminal, where the NCC may be parsed by the source DU, the NCC is used by the terminal to determine a first key in a handover execution process, and the first key is used by the terminal to communicate with a target cell.

Alternatively, in a case that the network side device is a source DU, the communication interface is configured to receive a next hop chaining counter NCC of a candidate cell from a source central unit CU; and a second sending module is configured to send a layer 1/layer 2 triggered mobility command for LTM handover to a terminal, where the command for LTM handover carries the NCC, the NCC is used by the terminal to determine a first key in a handover execution process, and the first key is used by the terminal to communicate with a target cell.

According to an eleventh aspect, a readable storage medium is provided. The readable storage medium stores a program or an instruction; and when the program or the instruction is executed by a processor, the steps of the method according to the first aspect are implemented, or the steps of the method according to the second aspect are implemented, or the steps of the method according to the third aspect are implemented.

According to a twelfth aspect, a wireless communication system is provided. The wireless communication system includes a terminal and a network side device. The terminal may be configured to perform the steps of the method according to the first aspect, and the network side device may be configured to perform the steps of the method according to the second aspect or implement the steps of the method according to the third aspect.

According to a thirteenth aspect, a chip is provided. The chip includes a processor and a communication interface. The communication interface is coupled to the processor, and the processor is configured to run a program or an instruction, to implement the method according to the first aspect, or implement the method according to the second aspect, or implement the steps of the method according to the third aspect.

According to a fourteenth aspect, a computer program/program product is provided. The computer program/program product is stored in a storage medium, and the program/program product is executed by at least one processor, to implement the method according to the first aspect, or implement the method according to the second aspect, or implement the steps of the method according to the third aspect.

### BRIEF DESCRIPTION OF DRAWINGS

FIG. 1 is a block diagram of a wireless communication system to which embodiments of this application are applicable;

FIG. 2 is a diagram of a CU-DU architecture;

FIG. 3A to FIG. 3C are example diagrams of a cell handover of a terminal;

FIG. 4 is a schematic diagram of an inter-CU cell handover procedure;

FIG. 5 is an example diagram of a derivation model of a key chain for a handover;

FIG. 6 is a diagram of an inter-base station handover procedure;

FIG. 7 is a schematic flowchart of a handover preparation process of an N2 handover;

FIG. 8 is a schematic flowchart of a handover process of an N2 handover;

FIG. 9 is a schematic flowchart of a transmission processing method according to an embodiment of this application;

FIG. 10 is a schematic flowchart of another transmission processing method according to an embodiment of this application;

FIG. 11 is a schematic flowchart of still another transmission processing method according to an embodiment of this application;

FIG. 12 is a schematic diagram of a structure of a transmission processing apparatus according to an embodiment of this application;

FIG. 13 is a schematic diagram of a structure of another transmission processing apparatus according to an embodiment of this application;

FIG. 14 is a schematic diagram of a structure of still another transmission processing apparatus according to an embodiment of this application;

FIG. 15 is a schematic diagram of a structure of a communication device according to an embodiment of this application;

FIG. 16 is a schematic diagram of a structure of a terminal according to an embodiment of this application; and

FIG. 17 is a schematic diagram of a structure of a network side device according to an embodiment of this application.

### DETAILED DESCRIPTION

The terms “first”, “second”, and the like in this application are used to distinguish between similar objects, instead of describing a specific order or sequence. It should be understood that the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions. To be specific, in a solution 1, A is included but B is not included; in a solution 2, B is included but A is not included; and in a solution 3, both A and B are included. The character “/” usually indicates an “or” relationship between associated objects.

The term “indication” in this application may be either a direct indication (or an explicit indication) or an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information based on an indication sent by the sender, or performs determining and determines an operation that needs to be performed, a request result, or the like based on a determining result.

It should be noted that the technologies described in embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. The terms “system” and “network” in embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to a system other than the NR system, for example, a 6^{th} generation (6G) communication system.

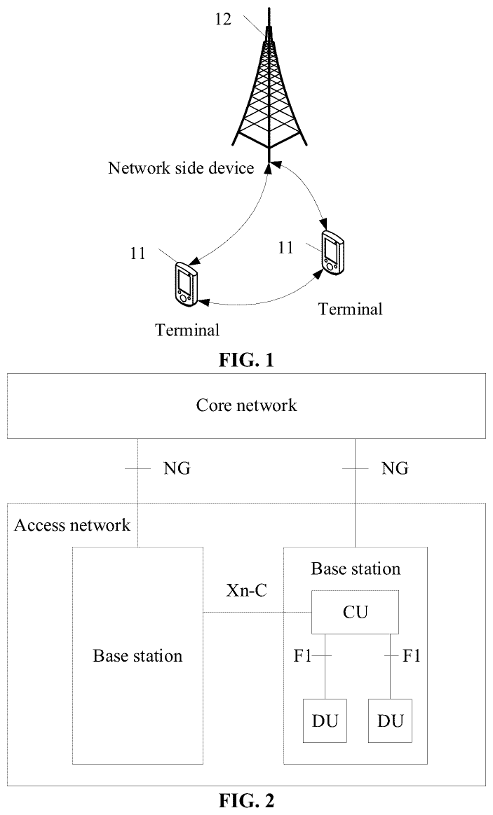

FIG. 1 is a block diagram of a wireless communication system to which embodiments of this application are applicable. The wireless communication system includes a terminal 11 and a network side device 12. The terminal 11 may be a terminal side device, for example, a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), a maritime user equipment, pedestrian user equipment (PUE), a smart home (a home device having a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, and the like), a smart wrist strap, smart clothes, and the like. A vehicle-mounted device may also be referred to as a vehicle-mounted terminal, a vehicle-mounted controller, a vehicle-mounted module, a vehicle-mounted component, a vehicle-mounted chip, or a vehicle-mounted unit. It should be noted that a specific type of the terminal 11 is not limited in embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. Provided that same technical effect is achieved, the base station is not limited to a specified technical term. It should be noted that in embodiments of this application, only a base station in an NR system is used as an example for description, and a specific type of the base station is not limited.

For ease of understanding, some content involved in embodiments of this application is described below.
1. CU-distributed unit (DU) framework.

An NR access network divides a base station into a central unit and a distributed unit, and is connected to the base station via an F1 interface. The CU-DU architecture in FIG. 2 is shown below. One base station includes one CU and one or more DUs, and one DU includes one or more cells. The CU includes the packet data convergence protocol (PDCP) or a protocol stack above, and the DU includes a protocol stack below a PDCP layer, for example, includes the radio link layer control (RLC) protocol, the medium access control (MAC) protocol, and the physical (PHY) layer protocol. On a control plane, the CU includes RRC and the control plane PDCP (PDCP-C). On a user plane, the CU includes the service data adaptation protocol (SDAP) and the user plane PDCP (PDCP-U).
2. Intra-CU and intra-DU handover.

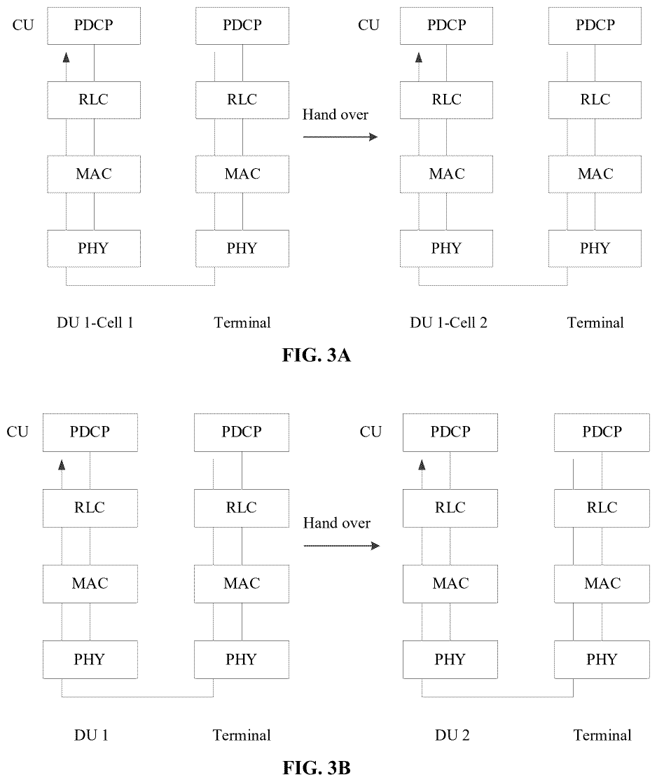

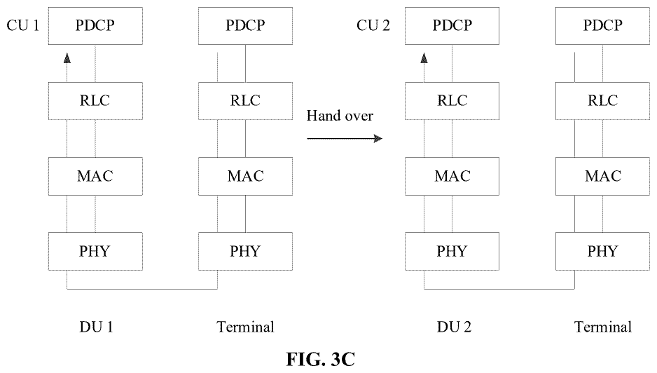

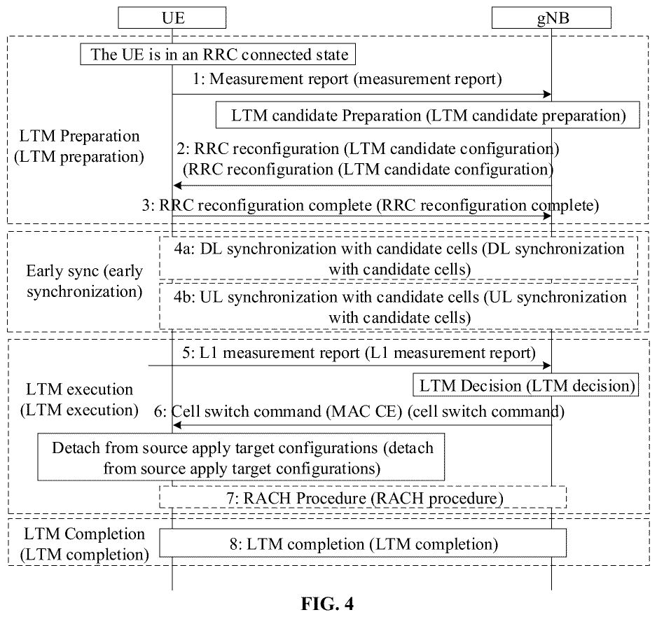

The terminal is handed over between different cells in a same DU in a same CU, as shown in FIG. 3A. When user equipment (UE) is handed over from a cell 1 of a DU 1 to a cell 2 of a DU 1, because physical locations of entities at layers on a base station side do not change, a PDCP entity and an RLC entity on a UE side are not affected. Because a cell serving the UE changes, a MAC layer of the UE needs to be reset.
3. Intra-CU and inter-DU handover, as shown in FIG. 3B. The UE is handed over from a specific cell of the DU 1 to a specific cell of the DU 2. Because the RLC entity and the MAC entity on the base station side change, the RLC layer of the UE needs to be re-established, the MAC layer needs to be reset, the PHY layer needs to be reconfigured, data recovery (Data Recovery) needs to be performed on the PDCP layer in an acknowledged mode (AM) bearer, and a data packet that has not been completely transmitted is retransmitted at the PDCP layer.
4. Inter-CU handover.

The terminal is handed over between different CUs (different base stations), as shown in FIG. 3C. The UE is handed over from the DU 1 of the CU 1 to the DU 2 of the CU 2. Therefore, the RLC layer needs to be re-established, the MAC layer needs to be reset, the PHY layer needs to be reconfigured, and the PDCP layer needs to be re-established.
5. LTM.

The LTM is introduced to reduce a handover delay. Based on a layer 1 measurement result reported by the terminal, the DU uses layer 1 (L1)/layer 2 (L2) signaling to indicate the terminal to be handed over to a suitable candidate cell. The LTM may support an inter-CU cell handover, and a specific procedure is shown in FIG. 4.

In this embodiment of this application, continuous LTM means that the UE is continuously handed over between a plurality of configured candidate cells, without a network reconfiguring the candidate cells.
6. Key derivation in a handover process.

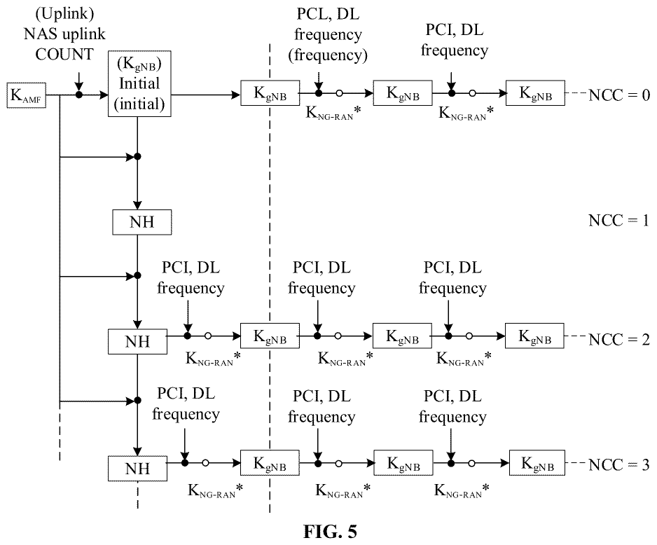

A derivation model of a key chain for a handover is shown in FIG. 5.

Optionally, when an initial connection is established, K_{gNB} is derived from an access and mobility management function (AMF), and is associated with NCC=0. For a horizontal or vertical derivation process during a subsequent handover, refer to the following descriptions.
7. Xn handover procedure.

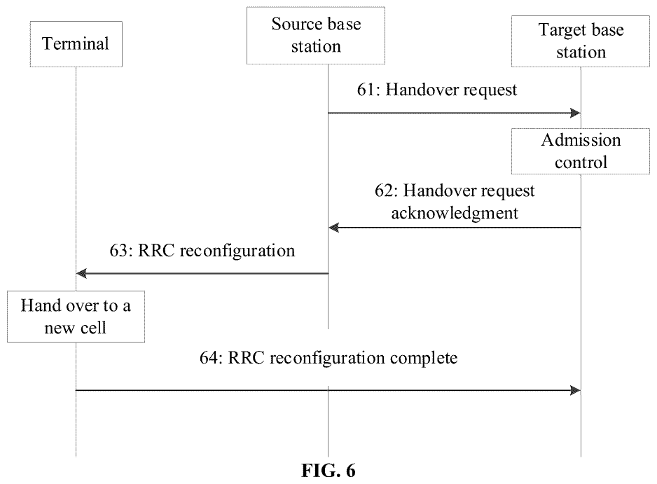

As shown in FIG. 6, an inter-gNB handover procedure includes at least the following steps:
Step 61: A source base station initiates a handover, and sends a handover request (HANDOVER REQUEST) to a target base station via an Xn interface.
Step 62: The target base station performs admission control, and provides an RRC configuration of a target cell in a handover request acknowledge (HANDOVER REQUEST ACKNOWLEDGE).
Step 63: The source base station forwards an RRC reconfiguration message carried in HANDOVER REQUEST ACKNOWLEDGE to a terminal.
Step 64: The terminal is disconnected from the source base station, establishes an RRC connection to the target base station, and replies with an RRC reconfiguration complete.
8. Key update in an Xn handover process.

The Xn handover means that an inter-CU handover is implemented via an Xn interface between the source base station and the target base station. A key derivation procedure in a handover process is as follows:
The procedure on a base station side is as follows:
   (a) When an unused {NH, NCC} pair exists in the source base station, vertical key derivation is performed; otherwise, horizontal key derivation is performed, where a value of a next hop (NH) is derived from a key K_{AMF} of an AMF. If vertical key derivation is performed, the source base station obtains K_{NG-RAN}* through calculation based on the NH by using a physical cell identifier (PCI) of the target cell and a frequency as an input. If horizontal key derivation is performed, the source base station obtains K_{NG-RAN}* through calculation based on a currently used key K_{gNB} by using a PCI of the target cell and a frequency as an input.
   (b) The source base station sends the {K_{NG-RAN}*, NCC} pair to the target base station. The target base station uses K_{NG-RAN}* as K_{gNB} when the UE is handed over to the target cell. The target base station associates the NCC with target K_{gNB}, includes the received NCC in a handover command message, and transparently transmits the handover command message to the source base station, and the source base station sends the handover command message to the UE.
   (c) After the handover is completed, the target base station sends a next generation application protocol (NGAP) path switch request (NGAP PATH SWITCH REQUEST) message to an AMF. After receiving the message, the AMF increases the locally stored NCC by 1 and derives a new NH based on K_{AMF}. The AMF sends new {NH, NCC} to the target base station by using an NGAP path switch request acknowledge (NGAP PATH SWITCH REQUEST ACKNOWLEDGE) for a subsequent handover, and deletes another stored {NH, NCC} pair.

A behavior on a terminal side is as follows:
When a UE side performs a handover, and applies an RRC configuration of the target cell,
   if an NCC value received by the UE in the handover command is the same as an NCC associated with currently used K_{gNB}/K_{eNB}, the UE derives K_{NG-RAN}* based on current K_{gNB}/K_{eNB}, a target PCI, and a frequency level; or
   if an NCC value received by the UE in the handover command is different from an NCC associated with currently used K_{gNB}/K_{eNB}, the UE first synchronizes the NCC with the NH until the NCC value matches the NCC indicated by the handover command. Then, the UE vertically derives K_{NG-RAN}* based on the synchronized NH, the target PCI, and the frequency.

The UE uses K_{NG-RAN}* as K_{gNB}/K_{eNB} for communication with the target base station.
9. N2 handover procedure.

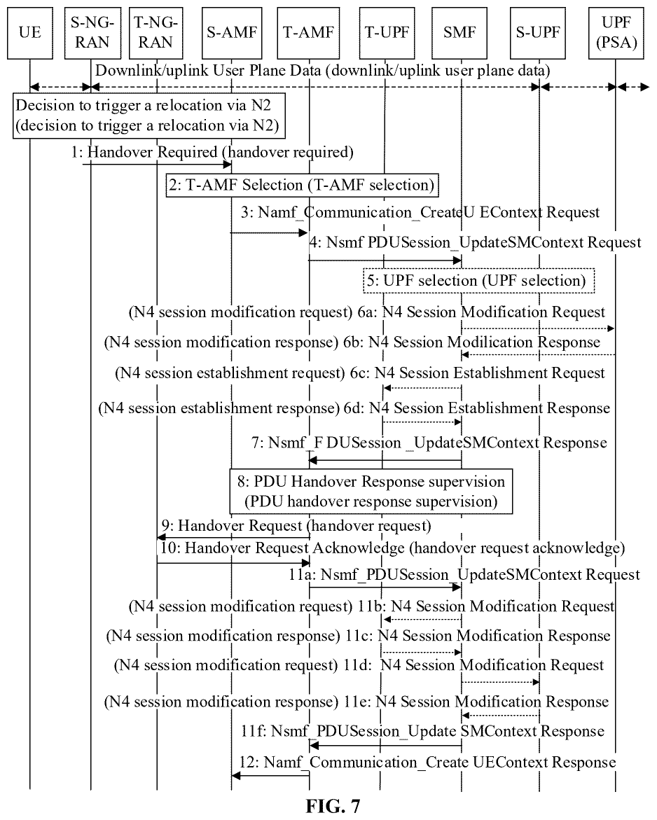

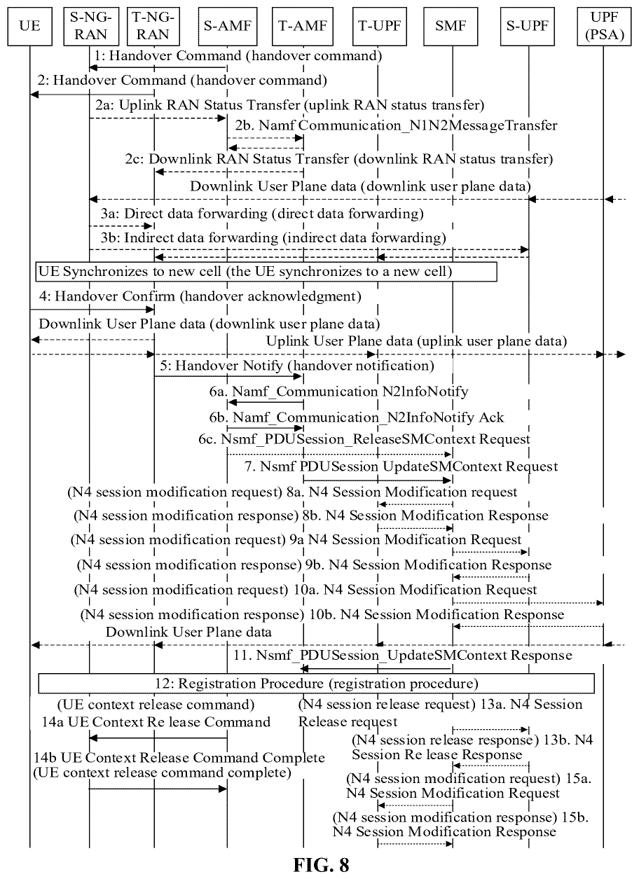

When there is no Xn interface, the terminal implements an inter-gNB N2 based handover (inter-gNB N2 based handover) through N2 interface signaling exchange. FIG. 7 shows a handover preparation process of an N2 handover. FIG. 8 shows a handover execution process of an N2 handover.

Optionally, in the N2 handover, because there is no Xn interface, a source gNB and a target gNB cannot directly exchange signaling, and a candidate target cell needs to be prepared via an NG interface. Main NG interface signaling involved includes:
HANDOVER REQUIRED from the source gNB to the AMF;
HANDOVER REQUEST sent by the AMF to the target gNB;
HANDOVER REQUEST ACKNOWLEDGE replied by the target gNB to the AMF; and

HANDOVER COMMAND replied by the AMF to the source gNB.

When the handover does not involve an AMF change, a source AMF (S-AMF) and a target AMF (T-AMF) in FIG. 7 and FIG. 8 are a same node, and signaling exchange therebetween may be omitted.
10. Key update in an N2 handover process.

In a case that the AMF does not change, behaviors on a base station side and a UE side are as follows:
Base station side:
   After an AMF receives an NGAP HANDOVER REQUIRED message, the source AMF increases a locally stored NCC value by 1, obtains a new NH through calculation based on K_{AMF}, and sends an {NH, NCC} pair to the target base station.

The target base station obtains K_{NG-RAN}* through calculation based on the NH, a target PCI, and a frequency, and the target base station uses K_{NG-RAN}* as K_{gNB} when the UE is handed over to the target cell. The target base station associates the NCC with target K_{gNB}, includes the received NCC in an HO Command message, and transparently transmits the HO Command message to the AMF, the AMF transparently transmits the HO Command message to the source base station, and the source base station sends the HO Command message to the UE by using an RRC reconfiguration message.

After the handover is completed, the target base station sends an NGAP PATH SWITCH REQUEST message to the AMF. After receiving the message, the AMF increases the locally stored NCC by 1 and derives a new NH based on K_{AMF}. The AMF sends new {NH, NCC} to the target base station by using an NGAP PATH SWITCH REQUEST ACKNOWLEDGE for a subsequent handover, and deletes another stored {NH, NCC} pair.

A behavior on a terminal side is the same as that in an Xn handover process. Details are not described herein again.
11. Data encryption and integrity protection.

Data encryption means that a transmit end generates a cipher (bit) stream based on an encrypted input parameter (for example, a serial number or a key); and performs an operation on the cipher (bit) stream and an original plaintext data stream (bit stream) to obtain an encrypted data stream. After receiving the encrypted data stream, a receive end obtains the decrypted data stream based on a reverse operation of the transmit end.

Integrity protection is to obtain a bit stream (MAC-I) of a preset length (for example, 32 bits) based on an input parameter (a serial number, a key, data to be integrity-protected, or the like). Any change in the input parameter may cause a change to the output MAC-I. The transmit end sends the MAC-I (referred to as MAC-I-1) together with to-be-integrity-protected data. After receiving the MAC-I, the receive end obtains the MAC-I (referred to as MAC-I-2) based on the to-be-integrity-protected data. The receive end compares the MAC-I-1 with the MAC-I-2. If the MAC-I-1 and the MAC-I-2 are the same, the receive end considers that the to-be-integrity-protected data is sent by the expected transmit end and has not been tampered with (it is assumed that an attacker does not have a key herein, and consequently, correct MAC-I cannot be generated after the data is tampered with), that is, the integrity check passes.

With reference to the accompanying drawings, a transmission processing method provided in embodiments of this application is described in detail by using some embodiments and application scenarios.

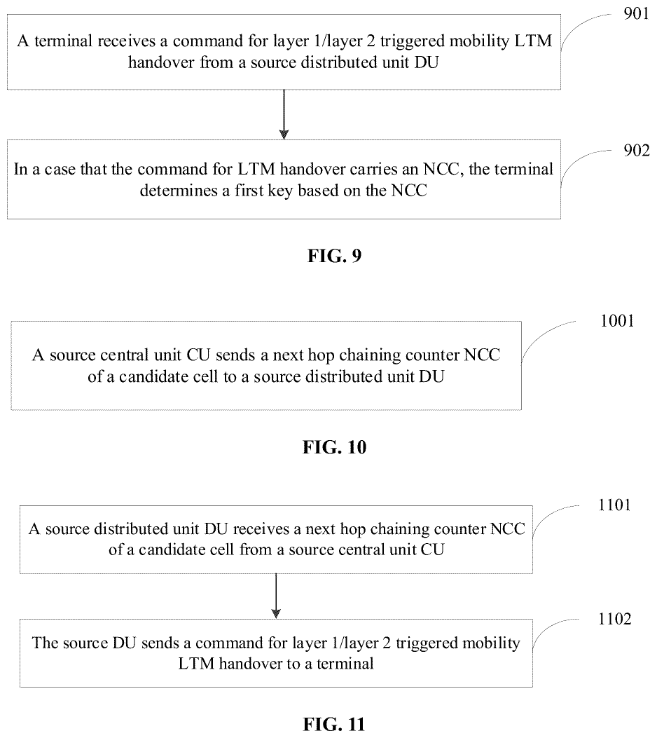

Refer to FIG. 9. An embodiment of this application provides a transmission processing method. As shown in FIG. 9, the transmission processing method includes the following steps.
Step 901: A terminal receives a command for layer 1/layer 2 triggered mobility LTM handover from a source distributed unit DU.
Step 902: In a case that the command for LTM handover carries a next hop chaining counter NCC, the terminal determines a first key based on the NCC.

The first key is used by the terminal to communicate with a target cell.

In this embodiment of this application, the source DU and the source CU may be understood as source base stations of the terminal. The source base station may be a base station in which a DU and a CU are separated, or may be a base station in which a DU and a CU are integrated. In a case that the CU and the DU are integrated, both the source CU and the source DU are source base stations. In a case that the CU and the DU are integrated, interaction between the CU and the DU is implemented based on a network.

Optionally, a target base station (including a base station of the target cell) to which the terminal is handed over based on the command for LTM handover may be a base station in which a target CU and a target DU are integrated.

Optionally, the command for LTM handover is used to trigger the terminal to perform an inter-CU handover. After receiving the command for LTM handover, the terminal may be handed over to the target cell. In a handover process and after the handover, the terminal may communicate with the target cell by using the first key.

Optionally, the command for LTM handover may be an L2 command, for example, may be MAC layer signaling, that is, the command for LTM handover may be a MAC control element (CE) or carried by a MAC CE.

In this embodiment of this application, the terminal receives the command for layer 1/layer 2 triggered mobility LTM handover from the source distributed unit DU. In a case that the command for LTM handover carries the next hop chaining counter NCC, the terminal determines the first key based on the NCC, where the first key is used by the terminal to communicate with the target cell. In this way, because the command for LTM handover is used to indicate the NCC, in a continuous handover process, the NCC may be obtained for each handover, and a communication key of the target cell may be generated, so that normal communication with the target cell can be ensured. Therefore, communication reliability is improved in this embodiment of this application. In addition, RRC reconfiguration on the terminal is avoided, thereby reducing a delay of continuous inter-CU handovers. Optionally, after that a terminal receives an command for LTM handover from a source distributed unit DU, the method further includes:
the terminal performs a first behavior, where the first behavior includes at least one of the following:
   performing integrity check on the command for LTM handover; and
   decrypting the command for LTM handover.

In this embodiment of this application, the source DU may perform at least one of the following:
performing integrity protection on the command for LTM handover, to generate MAC-I; and

encrypting the command for LTM handover.

It should be understood that when the terminal fails to perform integrity check or decryption, the terminal may notify a higher layer.

Optionally, the performing integrity check on the command for LTM handover includes at least one of the following:
in a case that the command for LTM handover carries the NCC, performing integrity check on the command for LTM handover; and
in a case that the command for LTM handover carries target indication information, and the target indication information indicates that the source DU performs integrity protection on the command for LTM handover, performing integrity check on the command for LTM handover.

In this embodiment of this application, in a case that the command for LTM handover does not carry the NCC, or the command for LTM handover is a regular command for LTM handover that does not carry the NCC, the source DU may not perform integrity protection on the command for LTM handover, and the terminal may not perform integrity check, so that a transmission difficulty and a transmission delay are reduced.

Optionally, the target indication information may be bit information of 1 bit. For example, when a value of the bit is 1, it indicates that the source DU performs integrity protection on the command for LTM handover, and the terminal needs to perform integrity check on the LTM command; or when the bit is 0, it indicates that the source DU does not perform integrity protection on the command for LTM handover, and the terminal does not need to perform integrity check on the command for LTM handover. In this way, specificity of integrity protection performed on the command for LTM handover is improved. For example, integrity protection may be performed only on the command for LTM handover that carries the NCC, and integrity protection is not performed on the regular command for LTM handover that does not carry the NCC, so that a transmission difficulty and a transmission delay are reduced.

In this embodiment of this application, at least one of integrity protection and encryption is performed on the command for LTM handover that carries the NCC, so that security of NCC transmission is improved.

Optionally, in some embodiments, after that a terminal receives an command for LTM handover from a source distributed unit DU, the method further includes:
in a case that the command for LTM handover carries the NCC, the terminal performs a second behavior, where the second behavior includes at least one of the following:
   resetting medium access control MAC;
   re-establishing radio link control RLC; and
   re-establishing the packet data convergence protocol PDCP.

In this embodiment of this application, resetting MAC may be understood as or replaced with performing reset on the MAC, re-establishing RLC may be understood as or replaced with re-establishing RLC of all bearers, including a signaling radio bearers (SRB) and a data radio bearer (DRB), and re-establishing the PDCP may be understood as or replaced with re-establishing the PDCPs of all bearers.

Optionally, after that a terminal receives an command for LTM handover from a source distributed unit DU, the method further includes:
in a case that the command for LTM handover does not carry the NCC, the terminal determines a third behavior based on a target condition, where the target condition is used to represent a relationship between a source cell and the target cell.

Optionally, the target condition includes any one of the following:
the source cell and the target cell have a same preset identifier;
a cell group configuration of the source cell and a cell group configuration of the target cell have a same preset identifier; and
the source cell and the target cell are in a same cell list.

In this embodiment of this application, the preset identifier may be understood as an identifier used to determine whether to perform an inter-CU handover.

Optionally, in some embodiments, in a case that the target condition is met, the third behavior includes at least one of the following: partially resetting MAC; resetting MAC; re-establishing RLC of an SRB; determining that RLC of a DRB is not re-established; PDCP discard of an SRB; and determining that PDCP data of a DRB is not recovered.

Optionally, in some embodiments, in a case that the target condition is not met, the third behavior includes at least one of the following: resetting MAC; re-establishing RLC; PDCP discard of an SRB; and recovering PDCP data of a DRB.

In this embodiment of this application, partially resetting MAC may be understood as or replaced with performing partial reset on the MAC; resetting MAC may be understood as or replaced with performing reset on the MAC; re-establishing RLC of an SRB may be understood as or replaced with performing re-establishment on the RLC of the SRB; in a case that it is determined that RLC of a DRB is not re-established, the RLC of the DRB is not re-established; PDCP discard of an SRB may be understood as or replaced with performing discarding on the PDCP of the SRB; and determining that PDCP data of a DRB is not recovered may be understood as or replaced with not performing recovery of the PDCP data of the DRB.

Optionally, re-establishing RLC may be understood as or replaced with performing re-establishment on RLC of all bearers, PDCP discard of an SRB may be understood as or replaced with performing discarding on the PDCP of the SRB, and recovering PDCP data of a DRB may be understood as or replaced with performing recovery of the PDCP data of the DRB.

Optionally, in some embodiments, that the terminal determines a first key based on the NCC includes:
the terminal determines, based on a locally stored NH and the NCC, a target NH corresponding to the NCC; and
the terminal determines the first key based on the target NH, a physical cell identifier PCI of the target cell, and a frequency of the target cell.

In this embodiment of this application, the terminal may store an NH corresponding to a key used previously, and then determine a quantity of times of synchronization calculation based on a difference between an NCC corresponding to a locally stored NH and the NCC in the handover command. Each time of synchronization calculation, an NH corresponding to a value obtained after the NCC corresponding to the locally stored NH increases by 1 may be obtained through calculation based on the locally stored NH and the value obtained after the NCC corresponding to the locally stored NH increases by 1, until the target NH corresponding to the NCC in the handover command is obtained through synchronization calculation.

To better understand this application, some examples are used for description below.

In some embodiments, a key of a network side device may be prepared via an Xn interface, and the DU notifies UE of the NCC via an LTM MAC CE.

A behavior of the network side device is as follows:
Step S00: The source CU derives a {K_{NG-RAN}*, NCC} pair vertically or horizontally based on the NH or current K_{gNB}, and sends the {K_{NG-RAN}*, NCC} pair to the target CU by using a HANDOVER REQUEST message; the target CU uses received K_{NG-RAN}* as a key K_{gNB} used when the terminal is handed over to a target gNB; the target CU associates the NCC with a target K_{gNB}, includes a target cell configuration in an HO Command message, and transparently transmits the HO Command message to the source CU; and the source CU sends the HO Command message to the UE by using an RRC reconfiguration message.

Optionally, the target CU may send the received NCC to the source CU by using a HANDOVER REQUEST ACKNOWLEDGE message.
Step S01: The source CU sends, to the source DU, the NCC associated with K_{gNB} of a candidate cell.
Step S02: The source DU sends the command for LTM handover to the UE, where the command for LTM handover carries the NCC.
Step S03: When the terminal is handed over to the target gNB, the target gNB uses K_{gNB} as a key used when the terminal communicates with the target gNB.
Step S04: After the handover is completed, the network side device re-prepares the NCC for a next handover through step S00 and step S01 (in this case, does not need to prepare a cell configuration of the target cell, or does not send an RRC reconfiguration message to the UE); and before the source DU receives an NCC of an inter-CU target cell, suspend indicating the UE to be handed over to the corresponding target cell, where the target cell is a candidate cell of the target gNB.

A behavior on a terminal side is as follows:
Step S10: The terminal receives a cell configuration, of a candidate cell, sent by the source CU by using an RRC reconfiguration message.

Step S11: The terminal reports a measurement result, and receives the command for LTM handover delivered by the source DU, where during an inter-CU handover, the command for LTM handover includes the NCC.

The target cell is a candidate cell of the target gNB, and may be determined based on the measurement result reported by the terminal.

Step S12: The terminal synchronizes a locally stored NH parameter to a corresponding NH parameter indicating the NCC in the command for LTM handover, and uses K_{NG-RAN}* obtained through calculation based on the synchronized NH, a physical cell identifier (PCI) of the target cell, and a frequency as the key (the first key) after the handover. In this case, the terminal ignores the NCC already included in the cell configuration of the target cell, and performs key derivation based on the NCC indicated in the command for LTM handover.

In this embodiment of this application, the NCC is sent to the UE by using an L2 command, and this avoids performing RRC reconfiguration on the UE in a continuous handover process.

Optionally, in some embodiments, when a handover is initiated, the source CU (S-CU) notifies the target CU (T-CU) of handover initiation and K_{NGRAN}*; and the source DU (S-DU) sends the NCC to the UE.

A behavior of the network side device is as follows:
Step S20: The source CU sends a HANDOVER REQUEST message to a candidate target CU to request a cell configuration; the candidate target CU sends a HANDOVER REQUEST ACKNOWLEDGE message to the source CU, where the HANDOVER REQUEST ACKNOWLEDGE message includes the cell configuration of the candidate cell; and the source CU sends an RRC reconfiguration message to the UE, where the RRC reconfiguration message includes the cell configuration of the candidate cell.
Step S21: The source CU sends, to the source DU, the NCC associated with K_{gNB} of the candidate cell.
Step S22: The source DU sends the command for LTM handover to the UE, where the command for LTM handover carries the NCC; and after the source DU sends the command for LTM handover to the UE, the source DU notifies the source CU of handover initiation, and notifies the CU of a target cell ID.
Step S23: The source CU uses, based on an NH or current K_{gNB} (the second key), a PCI of the target cell and a frequency as an input, derives a {K_{NG-RAN}*, NCC} pair vertically or horizontally, and sends the {K_{NG-RAN}*, NCC} pair to a target CU; the target CU uses received K_{NG-}RAN* as a key K_{gNB} used when the terminal is handed over to a target gNB; and the target CU associates the NCC with the target K_{gNB}.
Step S24: When the terminal is handed over to the target gNB, the target gNB uses K_{gNB} as a key used when the terminal communicates with the target gNB.

In this embodiment of this application, only when a handover is initiated, the source CU derives a key, and sends the key to the target CU. Because the target cell has been determined in this case, only one first key (K_{NG-RAN}*) needs to be derived; and the NCC is sent to the UE by using an L2 command. This avoids performing RRC reconfiguration on the UE in a continuous handover process.

Optionally, in some embodiments, when the command for LTM handover carries the NCC, at least one of integrity protection and encryption is performed on the command for LTM handover.

Manner 1: A MAC entity of the DU performs, by default, at least one of integrity protection (generating MAC-I) and encryption on the command for LTM handover; and a MAC entity of the UE performs at least one of integrity check and decryption on the command for LTM handover.

Manner 2: The command for LTM handover carries 1 bit, indicating whether integrity protection is performed; and if the command for LTM handover indicates that integrity protection is performed, the MAC entity of the UE performs integrity check on the command for LTM handover.

Manner 3: Integrity check is performed when the command for LTM handover carries the NCC.

For example, when the command for LTM handover carries the NCC, the MAC entity of the DU performs integrity protection on the command for LTM handover, and the MAC entity of the UE performs integrity check on the command for LTM handover; or when the command for LTM handover does not carry the NCC, the MAC entity of the DU does not perform integrity protection on the command for LTM handover, and the MAC entity of the UE does not perform integrity check on the command for LTM handover.

Optionally, if the UE fails to perform integrity check or decryption, the UE notifies a higher layer.

In this embodiment of this application, the command for LTM handover carries a key-related parameter NCC. Therefore, at least one of integrity check and decryption is performed on the command for LTM handover, so that security can be improved.

Optionally, in some embodiments, the terminal determines, based on whether the NCC exists in the command for LTM handover, how to perform L2 reset. Specifically, the following procedure may be included.
Step S30: The UE receives a plurality of candidate cell configurations from the source CU by using an RRC reconfiguration.
Step S31: The UE receives the command for LTM handover sent by the source DU.

For cases of different command for LTM handovers, the terminal performs different behaviors based on the command for LTM handovers. For example, the cases are as follows:
Case 1: If the command for LTM handover includes the NCC, the MAC of the terminal is reset, the RLC of all the bearers are re-established, the PDCPs of all the bearers are re-established, and the key of the target cell is derived based on the NCC indicated in the handover command.
Case 2: If the command for LTM handover does not include the NCC, the terminal determines whether the target condition is met.

Optionally, the target condition includes any one of the following:
the source cell and the target cell have a same preset identifier;
a cell group configuration of the source cell and a cell group configuration of the target cell have a same preset identifier; and
the source cell and the target cell are in a same cell list.

Optionally, if the target condition is met, the MAC of the terminal is reset or partially reset, the RLC of the SRB is re-established, the RLC of the DRB is not re-established, the PDCP of the SRB is discarded, and the PDCP data of the DRB is not recovered. If the target condition is not met, the MAC of the terminal is reset, the RLC of all the bearers is re-established, the PDCP of the SRB is discarded, and the PDCP data of the DRB is recovered.

In this embodiment of this application, the terminal can determine, based on the NCC, whether an inter-CU handover is performed and whether the PDCP needs to be re-established.

Refer to FIG. 10. An embodiment of this application further provides a transmission processing method. The method includes the following step.
Step 1001: A source central unit CU sends a next hop chaining counter NCC of a candidate cell to a source distributed unit DU, where the NCC is carried in a command for layer 1/layer 2 triggered mobility LTM handover sent by the source DU to a terminal.

The NCC may be parsed by the source DU, the NCC is used by the terminal to determine a first key in a handover execution process, and the first key is used by the terminal to communicate with a target cell.

In this embodiment of this application, the NCC is carried in an F1 interface message, and is located outside an RRC container.

Optionally, before that a source central unit CU sends an NCC of a candidate cell to a source distributed unit DU, the method further includes:
the source CU sends a handover request message to a candidate target CU, where the handover request message is used to request a cell configuration of the candidate cell;
the source CU receives a handover request acknowledge message from the candidate target CU, where the handover request acknowledge message carries the cell configuration of the candidate cell; and
the source CU sends a radio resource control RRC reconfiguration message to the terminal, where the RRC reconfiguration message includes the cell configuration of the candidate cell.

In this embodiment of this application, the candidate target CU may be understood as or replaced with a candidate CU, a candidate base station, or a CU of a candidate target base station.

Optionally, before that the source CU sends a handover request message to a candidate target CU, the method further includes:
the source CU determines a first key pair based on a next hop NH or a current second key of a source cell, where the first key pair includes a third key of the candidate cell and the NCC of the candidate cell; and
the source CU sends a first message to the candidate target CU, where the first message carries the first key pair.

In this embodiment of this application, the first message may be a handover request message.

Optionally, after that the source CU sends a first message to the candidate target CU, where the first message carries the first key pair, the method further includes:
the source CU receives a second message from the candidate target CU, where the second message carries the NCC.

Optionally, the second message may be a handover request acknowledge message.

Optionally, after that a source central unit CU sends an NCC of a candidate cell to a source distributed unit DU, the method further includes:
in a case that the source CU receives a cell switch notification from the source DU, the source CU determines a second key pair based on an NH or a current second key of a source cell, where the second key pair includes the NCC and the first key of the target cell; and
the source CU sends the second key pair to the target CU.

Optionally, that a source central unit CU sends an NCC of a candidate cell to a source distributed unit DU includes:
the source CU sends, to the source DU, the NCC and a candidate cell list associated with the NCC.

Refer to FIG. 11. An embodiment of this application further provides a transmission processing method. The method includes the following steps.
Step 1101: A source distributed unit DU receives a next hop chaining counter NCC of a candidate cell from a source central unit CU.
Step 1102: The source DU sends a command for layer 1/layer 2 triggered mobility LTM handover to a terminal.

The command for LTM handover carries the NCC, the NCC is used to determine a first key, and the first key is used by the terminal to communicate with a target cell.

Optionally, before that the source DU sends an command for LTM handover to a terminal, the method further includes:
the source DU performs a fourth behavior, where the fourth behavior includes:
   performing integrity protection on the command for LTM handover; and
   encrypting the command for LTM handover.

Optionally, the performing integrity protection on the command for LTM handover includes at least one of the following:
in a case that the command for LTM handover carries the NCC, performing integrity protection on the command for LTM handover; and
in a case that the command for LTM handover carries target indication information, and the target indication information indicates that the source DU performs integrity protection on the command for LTM handover, performing integrity protection on the command for LTM handover.

Optionally, after that the source DU sends a command for layer 1/layer 2 triggered mobility LTM handover to a terminal, the method further includes:
the source DU sends a cell switch notification to the source CU, where the cell switch notification includes an identifier of the target cell.

Optionally, that a source distributed unit DU receives a next hop chaining counter NCC of a candidate cell from a source central unit CU includes:
the DU receives, from the CU, the NCC and a cell list associated with the NCC.

The transmission processing method provided in embodiments of this application may be executed by a transmission processing apparatus. In embodiments of this application, the transmission processing apparatus according to embodiments of this application is described by using an example in which the transmission processing apparatus performs the transmission processing method.

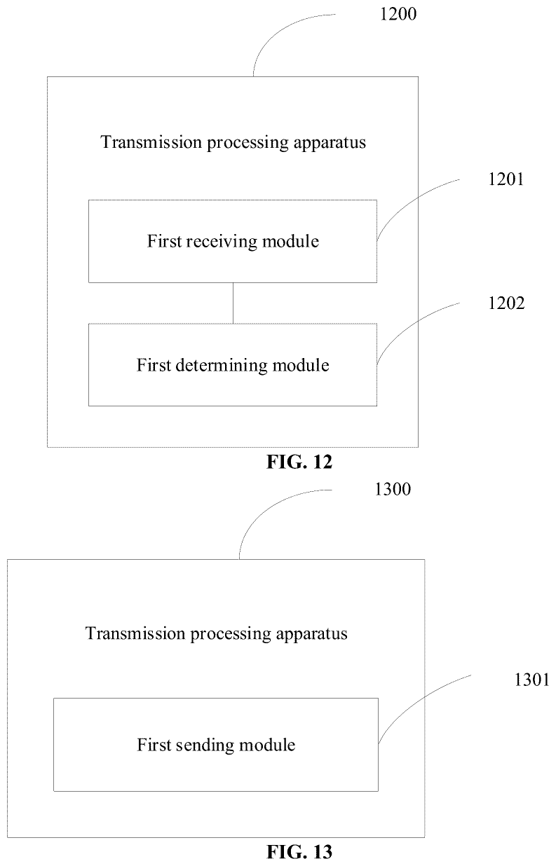

Refer to FIG. 12. An embodiment of this application further provides a transmission processing apparatus. As shown in FIG. 12, the transmission processing apparatus 1200 includes:
a first receiving module 1201, configured to receive a command for layer 1/layer 2triggered mobility LTM handover from a source distributed unit DU; and
a first determining module 1202, configured to: in a case that the command for LTM handover carries a next hop chaining counter NCC, determine a first key based on the NCC, where
the first key is used by a terminal to communicate with a target cell.

Optionally, the transmission processing apparatus 1200 further includes:
a first execution module, configured to perform a first behavior, where the first behavior includes at least one of the following:
   performing integrity check on the command for LTM handover; and
decrypting the command for LTM handover.

Optionally, the first execution module is specifically configured to perform at least one of the following:
in a case that the command for LTM handover carries the NCC, performing integrity check on the command for LTM handover; and
in a case that the command for LTM handover carries target indication information, and the target indication information indicates that the source DU performs integrity protection on the command for LTM handover, performing integrity check on the command for LTM handover.

Optionally, the transmission processing apparatus 1200 further includes:
a second execution module, configured to: in a case that the command for LTM handover carries the NCC, perform a second behavior, where the second behavior includes at least one of the following:
   resetting medium access control MAC;
   re-establishing radio link control RLC; and
   re-establishing the packet data convergence protocol PDCP.

Optionally, the first determining module 1202 is further configured to: in a case that the command for LTM handover does not carry the NCC, determine a third behavior based on a target condition.

The target condition includes any one of the following:
the source cell and the target cell have a same preset identifier;
a cell group configuration of the source cell and a cell group configuration of the target cell have a same preset identifier; and
the source cell and the target cell are in a same cell list.

Optionally, in a case that the target condition is met, the third behavior includes at least one of the following: partially resetting MAC; resetting MAC; re-establishing RLC of a signaling radio bearer SRB; determining that RLC of a data radio bearer DRB is not re-established; PDCP discard of an SRB; and not recovering PDCP data of a DRB.

Optionally, in a case that the target condition is not met, the third behavior includes at least one of the following: resetting MAC; re-establishing RLC; PDCP discard of an SRB; and recovering PDCP data of a DRB.

Optionally, the first determining module 1202 is specifically configured to:
determine, based on a locally stored NH and the NCC, a target NH corresponding to the NCC; and
determine the first key based on the target NH, a physical cell identifier PCI of the target cell, and a frequency of the target cell.

Refer to FIG. 13. An embodiment of this application further provides a transmission processing apparatus. As shown in FIG. 13, the transmission processing apparatus 1300 includes:
a first sending module 1301, configured to send a next hop chaining counter NCC of a candidate cell to a source distributed unit DU, where the NCC is carried in a command for layer 1/layer 2 triggered mobility LTM handover sent by the central unit DU to a terminal, where
the NCC may be parsed by the source DU, the NCC is used by the terminal to determine a first key in a handover execution process, and the first key is used by the terminal to communicate with a target cell.

Optionally, the transmission processing apparatus 1300 further includes: a third receiving module.

The first sending module 1301 is further configured to send a handover request message to a candidate target CU, where the handover request message is used to request a cell configuration of the candidate cell.

The third receiving module is configured to receive a handover request acknowledge message from the candidate target CU, where the handover request acknowledge message carries the cell configuration of the candidate cell.

The source CU sends a radio resource control RRC reconfiguration message to the terminal, where the RRC reconfiguration message includes the cell configuration of the candidate cell.

Optionally, the transmission processing apparatus 1300 further includes:
a second determining module, configured to determine a first key pair based on a next hop NH or a current second key of a source cell, where the first key pair includes a third key of the candidate cell and the NCC of the candidate cell.

The first sending module 1301 is further configured to send a first message to the candidate target CU, where the first message carries the first key pair.

Optionally, the transmission processing apparatus 1300 further includes: a third receiving module, configured to receive a second message from the candidate target CU, where the second message carries the NCC.

Optionally, the transmission processing apparatus 1300 further includes:
a second determining module, configured to: in a case that the source CU receives a cell switch notification from the source DU, determine a second key pair based on an NH or a current second key of the target cell, where the second key pair includes the NCC and the first key of the target cell.

The first sending module 1301 is further configured to send the second key pair to a target CU.

Optionally, the first sending module 1301 is specifically configured to send, to the source DU, the NCC and a candidate cell list associated with the NCC.

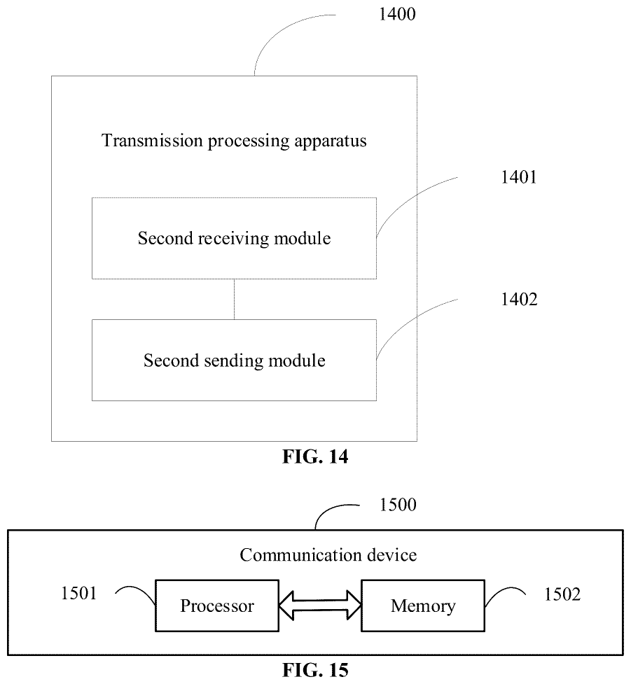

Refer to FIG. 14. An embodiment of this application further provides a transmission processing apparatus. As shown in FIG. 14, the transmission processing apparatus includes:
a second receiving module 1401, configured to receive a next hop chaining counter NCC of a candidate cell from a source central unit CU; and
a second sending module 1402, configured to send a command for layer 1/layer 2triggered mobility LTM handover to a terminal, where
the command for LTM handover carries the NCC, the NCC is used to determine a first key, and the first key is used by the terminal to communicate with a target cell.

Optionally, the transmission processing apparatus further includes:
a third execution module, configured to perform a fourth behavior, where the fourth behavior includes:
   performing integrity protection on the command for LTM handover; and
encrypting the command for LTM handover.

Optionally, the third execution module is specifically configured to perform at least one of the following:
in a case that the command for LTM handover carries the NCC, performing integrity protection on the command for LTM handover; and
in a case that the command for LTM handover carries target indication information, and the target indication information indicates that the source DU performs integrity protection on the command for LTM handover, performing integrity protection on the command for LTM handover.

Optionally, the second sending module 1402 is further configured to send a cell switch notification to the source CU, where the cell switch notification includes an identifier of the target cell.

Optionally, the second receiving module 1401 is specifically configured to receive, from the CU, the NCC and a cell list associated with the NCC.

The transmission processing apparatus in embodiments of this application may be an electronic device, for example, an electronic device having an operating system, or may be a component in the electronic device, for example, an integrated circuit or a chip. The electronic device may be a terminal, or another device that is not the terminal. For example, the terminal may include but is not limited to the foregoing listed types of the terminal 11, and the another device may be a server, a network attached storage (NAS), or the like. This is not specifically limited in embodiments of this application.

The transmission processing apparatus provided in embodiments of this application can implement the processes implemented in the method embodiments in FIG. 9 to FIG. 11, with same technical effect achieved. To avoid repetition, details are not described herein again.

As shown in FIG. 15, an embodiment of this application further provides a communication device 1500. The communication device includes a processor 1501 and a memory 1502. The memory 1502 stores a program or an instruction that can be run on the processor 1501. When the program or the instruction is executed by the processor 1501, steps of the transmission processing method embodiment are implemented, and same technical effect can be achieved. To avoid repetition, details are not described herein again.

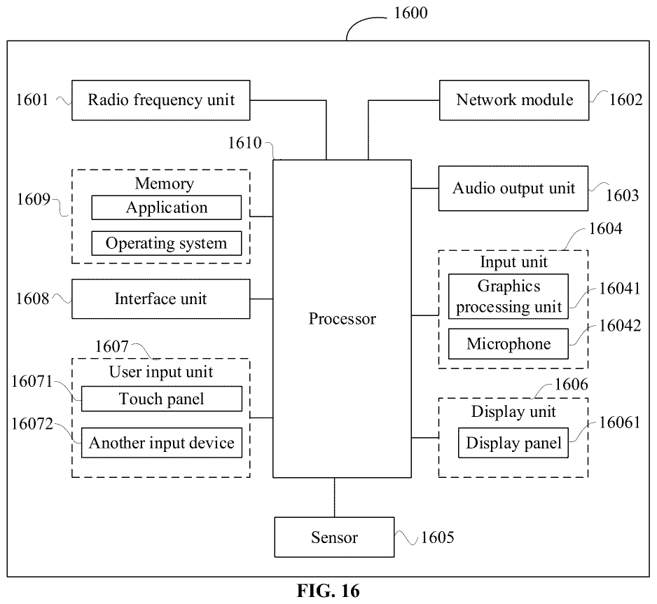

An embodiment of this application further provides a terminal. The terminal includes a processor and a communication interface, the communication interface is coupled to the processor, and the processor is configured to run a program or an instruction, to implement the steps of the method embodiment shown in FIG. 9. The terminal embodiment corresponds to the method embodiment on the terminal side, each implementation process and implementation of the method embodiment can be applied to the terminal embodiment, and same technical effect can be achieved. Specifically, FIG. 16 is a schematic diagram of a hardware structure of a terminal according to an embodiment of this application.

The terminal 1600 includes but is not limited to at least a part of components such as a radio frequency unit 1601, a network module 1602, an audio output unit 1603, an input unit 1604, a sensor 1605, a display unit 1606, a user input unit 1607, an interface unit 1608, a memory 1609, and a processor 1610.

A person skilled in the art can understand that the terminal 1600 may further include a power supply (such as a battery) that supplies power to each component. The power supply may be logically connected to the processor 1610 by using a power supply management system, to implement functions such as charging and discharging management, and power consumption management by using the power supply management system. The terminal structure shown in FIG. 16 constitutes no limitation on the terminal, and the terminal may include more or fewer components than those shown in the figure, or combine some components, or have different component arrangements. Details are not described herein.

It should be understood that in this embodiment of this application, the input unit 1604 may include a graphics processing unit (GPU) 16041 and a microphone 16042. The graphics processing unit 16041 processes image data of a static picture or a video obtained by an image capture apparatus (for example, a camera) in a video capture mode or an image capture mode. The display unit 1606 may include a display panel 16061, and the display panel 16061 may be configured in a form of a liquid crystal display, an organic light-emitting diode, or the like. The user input unit 1607 includes at least one of a touch panel 16071 and another input device 16072. The touch panel 16071 is also referred to as a touchscreen. The touch panel 16071 may include two parts: a touch detection apparatus and a touch controller. The another input device 16072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1601 may transmit the downlink data to the processor 1610 for processing. In addition, the radio frequency unit 1601 may send uplink data to the network side device. Usually, the radio frequency unit 1601 includes but is not limited to an antenna, an amplifier, a transceiver, a coupler, a low noise amplifier, a duplexer, and the like.

The memory 1609 may be configured to store a software program or an instruction and various data. The memory 1609 may mainly include a first storage area for storing a program or an instruction and a second storage area for storing data. The first storage area may store an operating system, and an application or an instruction required by at least one function (for example, a sound playing function or an image playing function). In addition, the memory 1609 may include a volatile memory or a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1609 in this embodiment of this application includes but is not limited to these memories and any memory of another proper type.

The processor 1610 may include one or more processing units. Optionally, an application processor and a modem processor are integrated into the processor 1610. The application processor mainly processes an operating system, a user interface, an application, and the like. The modem processor mainly processes a wireless communication signal, for example, a baseband processor. It may be understood that, alternatively, the modem processor may not be integrated into the processor 1610.

The radio frequency unit 1601 is configured to receive a command for layer 1/layer 2 triggered mobility LTM handover from a source distributed unit DU.

The processor 1610 is configured to: in a case that the command for LTM handover carries a next hop chaining counter NCC, determine a first key based on the NCC, where the first key is used by the terminal to communicate with a target cell.

It may be understood that, for an implementation process of the implementations mentioned in this embodiment, refer to related descriptions of the method embodiment on the terminal side, and same or corresponding technical effect may be achieved. To avoid repetition, details are not described herein again.

An embodiment of this application further provides a network side device. The network side device includes a processor and a communication interface, the communication interface is coupled to the processor, and the processor is configured to run a program or an instruction, to implement the steps of the method embodiment shown in FIG. 10 or FIG. 11. The network side device embodiment corresponds to the method embodiment of the network side device, each implementation process and implementation of the method embodiment can be applied to the network side device embodiment, and same technical effect can be achieved.

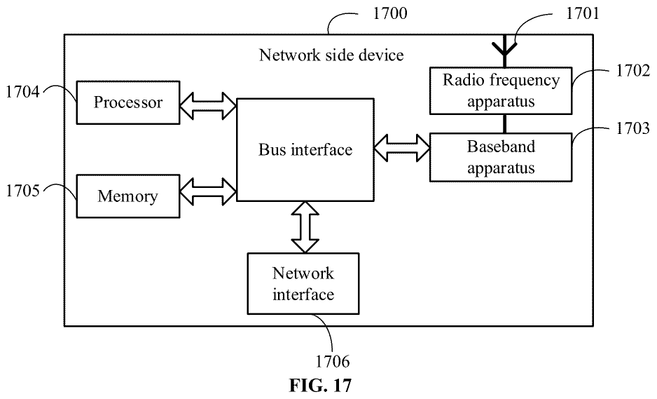

Specifically, an embodiment of this application further provides a network side device. As shown in FIG. 17, the network side device 1700 includes an antenna 1701, a radio frequency apparatus 1702, a baseband apparatus 1703, a processor 1704, and a memory 1705. The antenna 1701 is connected to the radio frequency apparatus 1702. In an uplink direction, the radio frequency apparatus 1702 receives information through the antenna 1701, and sends the received information to the baseband apparatus 1703 for processing. In a downlink direction, the baseband apparatus 1703 processes information that needs to be sent, and sends processed information to the radio frequency apparatus 1702. The radio frequency apparatus 1702 processes the received information, and sends processed information through the antenna 1701.

In the foregoing embodiment, the method performed by the network side device may be implemented in the baseband apparatus 1703. The baseband apparatus 1703 includes a baseband processor.

For example, the baseband apparatus 1703 may include at least one baseband board. A plurality of chips are disposed on the baseband board. As shown in FIG. 17, one chip is, for example, a baseband processor, and is connected to the memory 1705 through a bus interface, to invoke a program in the memory 1705 to perform the operations of the network device shown in the foregoing method embodiment.

The network side device may further include a network interface 1706, and the interface is, for example, a common public radio interface (CPRI).

Specifically, the network side device 1700 in this embodiment of this application further includes an instruction or a program that is stored in the memory 1705 and that can be run on the processor 1704. The processor 1704 invokes the instruction or the program in the memory 1705 to perform the method performed by the modules shown in FIG. 13 or 14, and same technical effect is achieved. To avoid repetition, details are not described herein again.

An embodiment of this application further provides a readable storage medium. The readable storage medium stores a program or an instruction. When the program or the instruction is executed by a processor, the processes in the foregoing transmission processing method embodiment are implemented, and same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, the processor is configured to run a program or an instruction, to implement the processes in the transmission processing method embodiment, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes in the transmission processing method embodiment, and same technical effect can be achieved. To avoid repetition, details are not described herein again.

An embodiment of this application further provides a communication system. The communication system includes a terminal and a network side device. The terminal may be configured to perform the steps of the transmission processing method on the terminal side, and the network side device may be configured to perform the steps of the transmission processing method on the source CU side or the source DU side.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by using a computer software product in addition to a necessary universal hardware platform, or certainly may be implemented by hardware. The computer software product is stored in a storage medium (such as a ROM, a RAM, a magnetic disk, or an optical disc), and includes several instructions for instructing a terminal or a network side device to perform the method described in embodiments of this application.

Embodiments of this application are described above with reference to the accompanying drawings. However, this application is not limited to the foregoing specific implementations, and the foregoing specific implementations are merely illustrative and not limitative.

What is claimed is:

1. A transmission processing method, comprising:
receiving, by a terminal, a command for layer 1/layer 2 triggered mobility (LTM) handover from a source distributed unit (DU); and
in a case that the command for LTM handover carries a next hop chaining counter (NCC), determining, by the terminal, a first key based on the NCC, wherein
the first key is used by the terminal to communicate with a target cell.

2. The method according to claim 1, wherein after the receiving, by a terminal, an command for LTM handover from a source distributed unit (DU), the method further comprises:
performing, by the terminal, a first behavior, wherein the first behavior comprises at least one of the following:
performing integrity check on the command for LTM handover; or
decrypting the command for LTM handover.

3. The method according to claim 2, wherein the performing integrity check on the command for LTM handover comprises at least one of the following:
in a case that the command for LTM handover carries the NCC, performing integrity check on the command for LTM handover; or
in a case that the command for LTM handover carries target indication information, and the target indication information indicates that the source (DU) performs integrity protection on the command for LTM handover, performing integrity check on the command for LTM handover.

4. The method according to claim 1, wherein after the receiving, by a terminal, an command for LTM handover from a source distributed unit (DU), the method further comprises:
in a case that the command for LTM handover carries the NCC, performing, by the terminal, a second behavior, wherein the second behavior comprises at least one of the following:
resetting medium access control (MAC);
re-establishing radio link control (RLC); or
re-establishing the packet data convergence protocol (PDCP).

5. The method according to claim 1, wherein after the receiving, by a terminal, an command for LTM handover from a source distributed unit (DU), the method further comprises:
in a case that the command for LTM handover does not carry the NCC, determining, by the terminal, a third behavior based on a target condition, wherein the target condition is used to represent a relationship between a source cell and the target cell.

6. The method according to claim 5, wherein the target condition comprises any one of the following:
the source cell and the target cell have a same preset identifier;
a cell group configuration of the source cell and a cell group configuration of the target cell have a same preset identifier; or
the source cell and the target cell are in a same cell list.

7. The method according to claim 5, wherein in a case that the target condition is met, the third behavior comprises at least one of the following: partially resetting (MAC); resetting MAC; re-establishing RLC of a signaling radio bearer (SRB); determining that RLC of a data radio bearer (DRB) is not re-established; PDCP discard of an SRB; or determining that PDCP data of a DRB is not recovered.

8. The method according to claim 5, wherein in a case that the target condition is not met, the third behavior comprises at least one of the following: resetting MAC; re-establishing RLC; PDCP discard of an SRB; or recovering PDCP data of a DRB.

9. The method according to claim 1, wherein the determining, by the terminal, a first key based on the NCC comprises:
determining, by the terminal based on a locally stored NH and the NCC, a target NH corresponding to the NCC; and
determining, by the terminal, the first key based on the target NH, a physical cell identifier (PCI) of the target cell, and a frequency of the target cell.

10. A transmission processing method, comprising:
sending, by a source central unit (CU), a next hop chaining counter (NCC) of a candidate cell to a source distributed unit (DU), wherein the NCC is carried in a command for layer 1/layer 2 triggered mobility (LTM) handover sent by the source DU to a terminal; and
the NCC may be parsed by the source DU, the NCC is used by the terminal to determine a first key in a handover execution process, and the first key is used by the terminal to communicate with a target cell.

11. The method according to claim 10, wherein before the sending, by a source central unit (CU), an NCC of a candidate cell to a source distributed unit (DU), the method further comprises:
sending, by the source CU, a handover request message to a candidate target CU, wherein the handover request message is used to request a cell configuration of the candidate cell;
receiving, by the source CU, a handover request acknowledge message from the candidate target CU, wherein the handover request acknowledge message carries the cell configuration of the candidate cell; and
sending, by the source CU, a radio resource control (RRC) reconfiguration message to the terminal, wherein the RRC reconfiguration message comprises the cell configuration of the candidate cell.

12. The method according to claim 10, wherein after the sending, by a source central unit (CU), an NCC of a candidate cell to a source distributed unit (DU), the method further comprises:
in a case that the source CU receives a cell switch notification from the source DU, determining, by the source CU, a second key pair based on an NH or a current second key of a source cell, wherein the second key pair comprises the NCC and the first key of the target cell; and
sending, by the source CU, the second key pair to the target CU.

13. The method according to claim 10, wherein the sending, by a source central unit (CU), an NCC of a candidate cell to a source distributed unit (DU) comprises:
sending, by the source CU to the source DU, the NCC and a candidate cell list associated with the NCC.

14. A transmission processing method, comprising:
receiving, by a source distributed unit (DU), a next hop chaining counter (NCC) of a candidate cell from a source central unit (CU); and
sending, by the source DU, a layer 1/layer 2 triggered mobility command for LTM handover to a terminal, wherein the command for LTM handover carries the NCC, the NCC is used to determine a first key, and the first key is used by the terminal to communicate with a target cell.

15. The method according to claim 14, wherein before the sending, by the source DU, an command for LTM handover to a terminal, the method further comprises:
performing, by the source DU, a fourth behavior, wherein the fourth behavior comprises:
performing integrity protection on the command for LTM handover; and
encrypting the command for LTM handover.

16. The method according to claim 15, wherein after the sending, by the source DU, a layer 1/layer 2 triggered mobility command for LTM handover to a terminal, the method further comprises:
sending, by the source DU, a cell switch notification to the source CU, wherein the cell switch notification comprises an identifier of the target cell.

17. The method according to claim 14, wherein the receiving, by a source distributed unit (DU), a next hop chaining counter (NCC) of a candidate cell from a source central unit (CU) comprises:
receiving, by the DU from the CU, the NCC and a cell list associated with the NCC.

18. A terminal, comprising a processor and a memory, wherein the memory stores a program or an instruction that can be run on the processor; and when the program or the instruction is executed by the processor, the steps of the transmission processing method according to claim 1 are implemented.

19. A network side device, comprising a processor and a memory, wherein the memory stores a program or an instruction that can be run on the processor; and when the program or the instruction is executed by the processor, the steps of the transmission processing method according to claim 10 are implemented.

20. A network side device, comprising a processor and a memory, wherein the memory stores a program or an instruction that can be run on the processor; and when the program or the instruction is executed by the processor, the steps of the transmission processing method according to claim 14 are implemented.
